(19) United States
(12) Patent Application Publication
(10) Pub. No.: US 2013/0138377 A1
(43) Pub. Date: May 30, 2013

(54) METHOD FOR COMPENSATING DRIFT IN A POSITION MEASURING DEVICE

(71) Applicant: C2SAT COMMUNICATIONS AB, Solna (SE)

(72) Inventor: Sven-Ake ERIKSSON, SILJANSNAS (SE)

(73) Assignee: C2SAT COMMUNICATIONS AB, Solna (SE)

(21) Appl. No.: 13/751,534

(22) Filed: Jan. 28, 2013

Related U.S. Application Data
(63) Continuation of application No. PCT/SE2011/050791, filed on Jun. 20, 2011.

(30) Foreign Application Priority Data
Jul. 29, 2010 (SE) 1050836-4

(51) Int. Cl. G01C 19/5776; G06F 17/00

(52) U.S. Cl. CPC G01C 19/5776; G06F 17/00
USPC 702/94

(57) ABSTRACT

Method for compensating the drift of a gyro mounted on a vessel subjected to at least rotational motions, about horizontal axes centered around an equilibrium position, and vertical translational motions, which vessel includes a three-axial accelerometer for measuring the acceleration of the vessel along three directions, includes low pass filtering the output signal from the gyro, calculating an inclination signal based upon the measurement values of the accelerometer and low pass filtering it, compensating the output signal from the gyro based upon the difference between the two low pass filtered signals, selecting the cut-off frequency of the low pass filtration of the inclination signal so that it is larger than a typical oscillation frequency for the translational motions but smaller than a typical oscillation frequency for the rotational motions, calculating a total force vector from the three measurement values, and calculating the inclination signal based upon the total force vector.

### FIELD OF THE INVENTION

The present invention relates to a method for compensating drift in a position measuring device comprising a gyro.

### BACKGROUND OF THE INVENTION

During for instance positioning of satellite antennas on movable objects, such as ships and other floating or flying vessels, or vessels on the ground, it is known to use gyros for directing a satellite antenna so that it at all times points towards a desired satellite in spite of the vessel moving in relation to the horizontal plane and the plumb line.

One problem with position measuring means comprising gyros is that gyros in general drift gradually. It is known to use a low pass filtered accelerometer signal in order to compensate for such gyro drift.

Both Swedish patent no. SE531778, U.S. Pat. No. 6,588,117 and the articles Hong, S K: “Fuzzy logic based closed-loop strapdown attitude system for unmanned aerial vehicle (UAV)”, Sensors and Actuators A, Elsevier Sequoia S. A., Lausanne, C H, vol. 107, no. 2, 15 Oct. 2003, pages 109-118, and Majima S et al.: “A Controller for Changing the Yaw Direction of an Underactuated Unicycle Robot”, 5th International Conference on Technology and Automation (15-16 Oct. 2005), http://icta05.teithe.gr/index.php, describe methods for performing such gyro compensation on various movable vessels such as boats and airplanes.

All these methods are based upon the assumption that the vessel turns or rotates about a fixed equilibrium position in which the vessel is in an operative position, that the output signal from an accelerometer can be low pass filtered whereby the noise that such rotations represent are eliminated, and that the thus low pass filtered signal therefore can be used for drift compensating the gyro.

The above said Swedish patent does not take into consideration that different types of oscillating motions of for example a ship have different typical frequencies, whereof some such oscillations may have essentially lower frequencies than others. Motions of the vessel with a period which is longer than the cut-off frequency of the said low pass filtration will, however, not be eliminated by the low pass filtration.

For example, motions of long period comprise sea heavings in a boat, extended accelerations, retardations and turns.

The above US patent and article both suffer from the problem that they are unable to in a satisfying manner handle vertical translation motions of the vessel.

### SUMMARY OF THE INVENTION

The present invention solves the above described problems. Thus, the invention relates to a method for compensating the drift of a position measuring means mounted on a vessel which during operation is subjected to at least rotational motions which are centered about an equilibrium position which is assumed by the vessel during operation, which rotational motions are performed about one or several axes which in the equilibrium position are horizontal, as well as vertical translational motions, which vessel furthermore comprises at least one gyro for measuring the rotation of the vessel about an axis and a three-axial accelerometer for measuring the acceleration of the vessel along three directions which together span the three-dimensional space, where the output signal from the gyro is caused to be low pass filtered so that a low pass filtered gyro signal is achieved, where an inclination signal, which is caused to be comprised by the measurement value of the accelerometer or to be calculated from the measurement values of the accelerometer, which inclination signal represents rotation of the vessel about said axis, is caused to be low pass filtered so that a low pass filtered inclination signal is achieved, where a controller is caused to compensate the output signal from the gyro regarding gyro drift, which compensation is based upon the difference between the two low pass filtered signals.

The invention is characterised in that the cut-off frequency of the low pass filtration of the inclination signal is selected so that it is larger than at least a typical oscillation period for the vertical translation motions, in that a total force vector is caused to be calculated based upon the three measurement values of the accelerometer (20), which total force vector represents the total acceleration of the vessel (1), and in that the inclination signal is caused to be calculated based upon the total force vector.

### BRIEF DESCRIPTION OF THE DRAWINGS

In the following, the invention will be described in detail, with reference to exemplifying embodiments of the invention and to the appended drawings, where:

FIG. 1 illustrates a coordinate system with a vessel; and

FIG. 2 shows a block diagram describing a method according to the present invention.

### DETAILED DESCRIPTION OF THE INVENTION

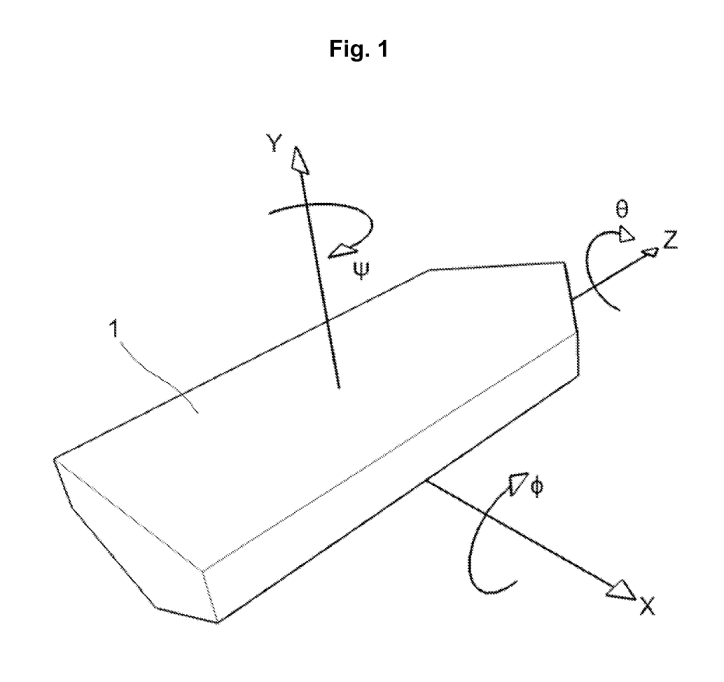

In FIG. 1, a coordinate system is shown which relates to a vessel 1, exemplified with a ship. In FIG. 1, the Y axis points perpendicularly upwards from the vessel, the Z axis in the longitudinal axis of the vessel in the forward direction, and the X axis perpendicularly across the longitudinal axis of the vessel. When the vessel rolls sideways, it rotates in the rotational direction θ about the Z axis. When the vessel pitches in the longitudinal direction, it rotates in the rotational direction φ about the X axis. When the vessel changes its heading, it rotates in the rotational direction is about the Y axis. It is realized that the same coordinate system is useful for other types of floating or flying vessels, or vessels on the ground, that move about an equilibrium position where the vessel is in an upright position, such as other types of boats, airplanes, helicopters, cars, and so forth.

During operation, the vessel 1 is subjected to rotational motions which are centered about the upright equilibrium position in which the vessel is shown in FIG. 1. The rotational motions are performed about one or several axes which in the equilibrium position are horizontal, in other words the roll θ and pitch φ directions in the example at hand. Moreover, during operation the vessel 1 is subjected to vertical translational motions, that is motions in the vertical direction Y. For such motions, a method according to the present invention achieves a satisfactory result, even if the method can be implemented, such as is described below, for also achieving a satisfactory gyro drift compensation when the vessel is subjected to motions in the directions ψ, X and Z.

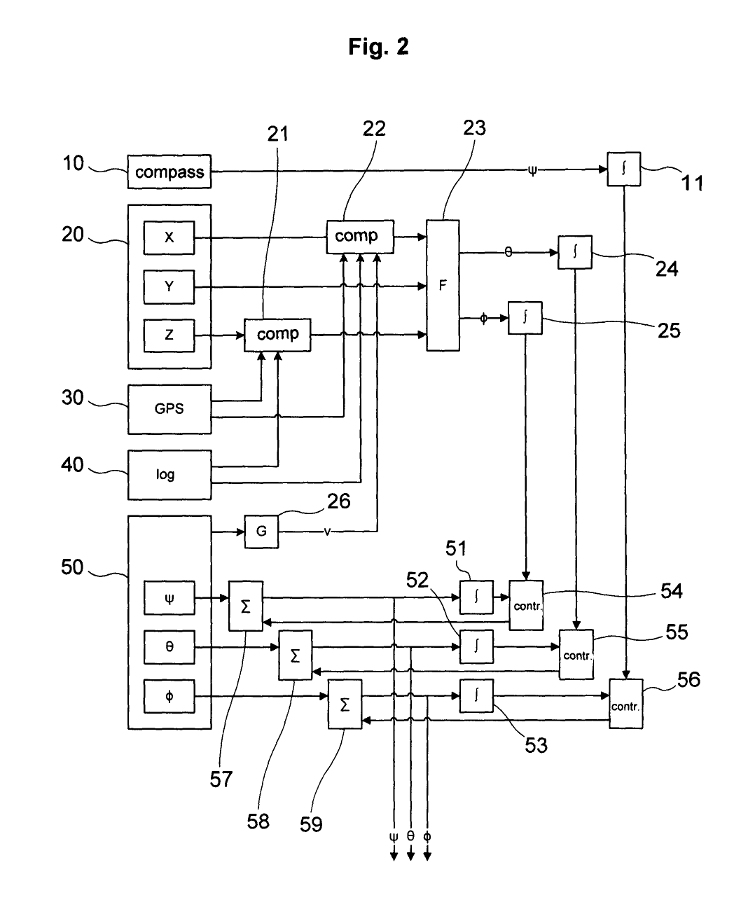

FIG. 2 illustrates, using a block diagram, a method according to the present invention. A gyro 50 measures the instantaneous relative rotation of the vessel 1 in at least one of the rotational directions θ and φ, preferably in all rotational directions ψ, θ and φ, which latter case is shown in FIG. 2. The gyro 50 preferably measures the measured angles in one and the same point, and preferably comprises a three-axial gyro in one unit. The gyro 50 is fixedly mounted on the vessel 1, where it is arranged as a part of a position measurement means, preferably for determining a position of the vessel 1 in relation to some object the position of which in turn is known, such as a satellite. The position of the vessel 1 herein denotes its angular position in relation to such an object, and possibly also its geographical position as well as altitude above sea level in relation to such an object.

Moreover, the vessel 1 comprises a fixedly mounted, three-axial accelerometer 20 for measuring the acceleration of the vessel 1 along three directions. It is preferred that the directions are orthogonal, and preferably that they are parallel to axes X, Y and Z. However, a method according to the invention can be applied as long as the three directions are not found in the same plane, since they then together span three-dimensional space. It is preferred that the accelerometer 20 is arranged to measure the acceleration in the different directions in one single point.

Examples of suitable gyros are gyros which are sold under the trade name KVH DSP-3000 by the company KVH Industries, Inc. One example of a suitable accelerometer is one which is marketed by STMicroelectronics in Geneva, Switzerland. The accelerometer is sampled with a frequency which is suitable for the current application, preferably between 5 and 50 times per second.

Each of the instantaneously measured angles ψ, θ and φ, which constitute output signals from the gyro 50, are low pass filtered in a respective low pass filtration step 51, 52, 53, whereby a low pass filtered gyro signal is achieved for each of the angular values.

The instantaneously measured values from the accelerometer 20 are sent to a calculation module 23, which calculates an inclination signal based upon the values from the accelerometer 20 according to a predetermined, conventional function F. It is realized that an analogue method is applied in case the accelerometer 20 as an output value delivers a ready-calculated inclination signal, whereby the output signal from the accelerometer 20 may be split up into components that thereafter may be used in the further method steps. In the following, an accelerometer which delivers a separate output signal for each axial direction is described.

The said inclination signal is arranged to represent rotation of the vessel 1 about at least one of the above said horizontal rolling θ and pitching φ axes, and the predetermined function F is constituted by matrix transformations and geometric calculations that accept the output values of the accelerometer 20 as input parameters. The calculated inclination signals are thereafter low pass filtered in respective low pass filtration steps 24, 25, so that a low pass filtered inclination signal is achieved.

Furthermore, a respective controller 54, 55, 56 is arranged to compensate at least one of the respective output signals from each of the angular values φ, θ and φ of the gyro 50, which are measured by the gyro 50, preferably all of these output signals, so that the drift of the gyro 50 is eliminated and the rotation values become correct and reliable. The controllers 54, 55, 56 may be implemented as discreet components or be comprised by different functions in one and the same controller.

The compensation is based upon the difference between the two low pass filtered signals from, on the one hand, the gyro 50 and, on the other hand, the accelerometer 20.

The rotational motions of the vessel 1 are measured, as described above, simultaneously by both the accelerometer 20 and the gyro 50. As is described in more detail in the above mentioned Swedish patent no SE531778, a gyro is well suited for measuring small relative angular changes, but suffers from the problem of gyro drift over time, which makes absolute angles not reliably measurable. An accelerometer, on the other hand, is well suited for measuring absolute angles under static conditions, but is on the other hand less suited for measuring changes under dynamic conditions, and is sensitive to translational accelerations that disturb the measurement of changes in absolute angles.

Each respective controller 54, 55, 56 thus accepts as an input value firstly a low pass filtered signal from the accelerometer 20, secondly a low pass filtered, drift compensated (see below) signal from the gyro 50, which two signals represent the rotation about the same axis. Based upon the two signals, the controller 54, 55, 56 then calculates a compensating signal which is added, in a respective addition module 57, 58, 59, to the instantaneous value from the respective gyro axis. Hence, the respective output values from the addition modules 57, 58, 59 constitute both input parameters to the respective low pass filters 51, 52, 53 and finally drift compensated gyro values ψ, θ and φ.

Since the rotational motions of the vessel 1 in directions θ and φ are centered about said equilibrium position, the low pass filtered inclination value from the accelerometer 20 concerning these rotations constitutes a very exact value on the equilibrium position of the vessel in relation to the mounting orientation of the accelerometer 20. The same is true regarding the gyro 50. Thereby, the negative difference between these two signals to a first approximation constitutes a suitable compensation signal, which may serve to continuously calibrate the instantaneous signal of the gyro 50. However, it is preferred that each respective controller 54, 55, 56 implements a suitably calibrated control algorithm of the PID type, for example an algorithm of the PD type.

It is preferred that both the low pass filtration of the accelerometer signal and of the gyro signal have the same cut-off frequency, in order to achieve good results for motions of the vessel 1 with different typical frequencies.

For motions of the vessel 1 where the vessel oscillates about the above mentioned equilibrium position, a compensation of the above described type works as long as the oscillations about the equilibrium position have frequencies which are substantially higher than the cut-off frequency for the above described low pass filtration of the accelerometer signal. For motions of lower frequency, the results typically do not become satisfactory, since the low pass filtered accelerometer signal then will comprise long periodic noise which will affect the gyro drift compensation.

If a cut-off frequency for the low pass filtration of the inclination signal is selected which is sufficiently low to catch and leveling out also low-frequency motions, the latency of the gyro compensation will on the other hand be too long in order to achieve sufficiently exact results in many applications when on water, at sea or when a vessel moves on the ground in uneven terrain.

According to the invention, the cut-off frequency for the low pass filtration of the inclination signal is therefore selected so that it is larger than at least a typical period for the vertical translation motions. In other words, the cut-off frequency is selected so that it is larger than the frequency for the motions with the longest period which are characteristic for the vertical translational motions. Such a selection of cut-off frequency gives sufficiently rapid response times at the same time as the longer period vertical translation motions can be compensated for according to what is described in the following.

According to an especially preferred embodiment, the cut-off frequency is furthermore selected so that it is lower than the typical periods for turning motions about the above described equilibrium position during normal travel with the vessel 1 in a direction straight ahead with no course changes.

A type of low frequent disturbing motions which typically and above all are present in open sea applications, but also in the air and on the ground, is vertical translation motions of the vessel 1. At sea, these are constituted by relatively slow sea heavings, in the air by altitude changes, on the ground by changes of the ground altitude above the sea level.

According to the invention, the module 23 calculates a total force vector from the three measurement values X, Y, Z of the accelerometer 20, where the total force vector represents the total instantaneous acceleration of the vessel 1, including the acceleration of gravity and any additionally imparted acceleration as a consequence of the motions of the vessel 1. Thereafter, the module 23 calculates the inclination signal based upon the calculated total force vector, for example according to the following:

$$\text{?} {sin}^{- 1} ( \frac{X}{{F}_{total}} ) ;$$

$$\text{?} {sin}^{- 1} ( \frac{Y}{{F}_{total}} ) ;$$

$${F}_{total} \text{?} \sqrt{{X}^{2} + {Y}^{2} + {Z}^{2}} . \\ \text{?} \text{indicates text missing or illegible when filed}$$

Since the acceleration of the vessel which arises as a consequence of vertical translation motions is parallel to the acceleration of gravity, the calculated values for angles θ and φ will be independent of vertical acceleration contributions, especially independent of the above described low frequency, vertical motions. This is not the case with the initially mentioned, previously known methods for drift compensating gyros, since they all use only two accelerometer axes in order to calculate an inclination angle which in turn is used to drift compensate a gyro. Thereby, low frequency, vertical motions will disturb the calculated inclination angles and therefore the gyro compensation.

As a vessel moves, also other types of low frequency motions arise, giving rise to disturbing accelerations. In general, the type of acceleration contributions of the type being caused via the controls of the vessel 1 for maneuvering may however be calculated by aid of information which may be made available using existing or purpose-installed sensors on board the vessel 1, why acceleration contributions of this type may be considered known.

According to a preferred embodiment, the measurement values of the accelerometer 20 are continuously adjusted, so that they are compensated for possible such known acceleration of the vessel 1 which instantaneously is achieved via the controls of the vessel for maneuvering. This compensation is achieved by modifying the instantaneous accelerometer signals before the calculation of the inclination signal by the module 23, and is accomplished by subtracting the respective corresponding component of the known acceleration from the corresponding measurement value from the accelerometer 20.

The expression “possible acceleration” is intended to seize upon that such a known acceleration is not always present, but may be zero, for example during level flight with an airplane.

FIG. 2 illustrates a pair of examples of such compensation of the accelerometer signal.

In case the known acceleration is constituted by a possible linear acceleration or retardation in the direction of travel of the vessel 1, the measurement values of the accelerometer 20 are compensated based upon input data from a speedometer arranged on the vessel 1, for instance in the form of an existing GPS receiver 30, an existing log 40, or another suitable device for measuring velocity. The speedometer 30, 40 continuously measures the velocity of the vessel 1, and any acceleration or retardation in the direction of travel is calculated based upon the measured velocity. Finally, the calculated acceleration value is subtracted from the output signal from the accelerometer 20, which thereby is adjusted. In case the accelerometer 20 is arranged to measure the acceleration in the Z direction directly, since one of its measurement directions coincides with the longitudinal direction of the vessel 1 such as is illustrated in FIG. 2, the acceleration is simply subtracted from the instantaneous Z measurement value. Otherwise, the output values of the accelerometer 20 are modified using suitable matrix transformations so that the corresponding effect is achieved.

The subtraction is carried out in a calculation module 21, which also may comprise a controller, which is conventional as such, in order to carry out a suitable control engineering modification of the instantaneous signal from the accelerometer 20 which is more complex than a simple subtraction, such as for example a PID control.

In case the known acceleration is carried out by a possible centrifugal force acting perpendicularly to the direction of travel of the vessel and arising as a consequence of the vessel 1 yawing, that is turning during travel forward or backward in the direction of travel Z, the measurement values of the accelerometer 20 are compensated based upon input data both from a speedometer arranged on the vessel 1, as described above, and from a measurement device which continuously measures the rotation of the vessel per unit time. If the velocity v (as measured in m/s) and the rotation per unit time Ω (in radians/s) are known, it is thus true that the measurement value of the accelerometer in the X direction is altered by the value τ·Ω.

Hence, the X measurement value of the accelerometer 20 is adjusted using a calculation module 22, which similarly to the module 21 can comprise a more advanced controller which for example is of a suitable PID type, and which module 22 accepts input data both from the GPS receiver 30, the log 40 or another suitable speedometer as well as from the device for measuring the rotation per unit time.

According to a preferred embodiment, the said device for measuring the turning per unit time is constituted by the gyro 50 itself, the output signal of which passes through a calculation module 26, which based upon the output signal from the gyro 50, in a way which is conventional as such and uses a predetermined function G, calculates the instantaneous angular change per unit time in the current yawing plane.

This way, the measurement value of the accelerometer 20 is thus adjusted continuously in the X direction, so that it is compensated for the known centrifugal force perpendicularly to the direction of travel of the vessel 1, by the calculated value being subtracted from the X measurement value of the accelerometer 20, which in this case is measured along an axis which is arranged in the above described horizontal plane in the equilibrium position, and perpendicularly to the direction of travel of the vessel 1. In the same way as described above regarding accelerations in the direction of travel of the vessel 1, the measurement value of the accelerometer 20 may be adjusted in a corresponding manner, using suitable matrix transformations, if none of its measurement directions is perpendicular to the direction of travel and arranged in the horizontal plane.

In the above described example, where the output value of the accelerometer 20 is continuously adjusted for centrifugal forces as a consequence of yawings of the vessel 1, the instantaneous output signal from the gyro 50 is thus used for continuously compensating the instantaneous output signal from the accelerometer 20, at the same time as the low pass filtered output signal from the accelerometer 20 in combination with the low pass filtered output signal from the gyro 50 is used to compensate the instantaneous output signal from the gyro 50. The same principle may also be used under other conditions where centrifugal forces are imparted to the vessel 1 via its maneuvering means, such as during turning of an airplane in the vertical plane, such as when commencing an ascent.

As mentioned above, it is preferred that the gyro 50 is arranged to measure rotation about three orthogonal axes that preferably coincide with the axes X, Y and Z as marked out in FIG. 1.

In this case, as to the rotation θ, about the direction Z of travel of the vessel 1, and φ, about an axis X which is perpendicular to the direction Z of travel of the vessel 1 and also perpendicular to the plumb line when the vessel 1 is in the above described equilibrium position, it is preferred that these rotation measurement values are drift compensated using the low pass filtered inclination signal as described above.

On the other hand, as to the turning measured by the gyro 50 in the direction ψ, namely the rotation of the vessel 1 about an axis Y which is parallel to the plumb line when the ship 1 is in the equilibrium position, it is preferred that this rotation measurement value is drift compensated using a low pass filtered signal from an existing compass 10 on the vessel 1, for example an accurate gyrocompass. Low pass filtration is accomplished by a low pass filtration step 11, which is similar to the low pass filtration steps 24, 25 and which also preferably uses the same cut-off frequency for the low pass filtration as the steps 24, 25. The low pass filtered signal form the step 11 is fed to the controller 56 in a way which corresponds to the one described above for steps 24, 25 in combination with controllers 54, 55.

Thus, a method according to the present invention achieves that a gyro in a position determining means, which means is fixedly mounted on a vessel, may be compensated for gyro drift in a simple and reliable way, even under conditions with low frequent disturbances of the type vertical heavings and various other low frequency, disturbing accelerations. Moreover, the gyro drift compensation takes place using components which are conventional as such and also often already existing on the vessel, which results in low costs.

Above, preferred embodiments have been described. However, it is apparent to the skilled person that many modifications may be made to the described embodiments without departing from the idea of the invention.

For example, it is realized that a method according to the present invention advantageously may be used for drift compensating a gyro based position measuring means which is fixedly mounted on any type of vessel which is arranged to travel afloat, flying or on the ground, and which displays the above described relatively high frequency motions centered about an equilibrium position. One example is a helicopter, the equilibrium position of which for instance is constituted either by its normal angular position during horizontal flight or of its normal angular position during hovering.

Thus, the invention shall not be limited to the described embodiments, but may be varied within the scope of the enclosed claims.

1-12. (canceled)

13. Method for compensating for gyro drift of a gyro (50) which is fixedly mounted on a vessel (1) as a part of a position measuring means, which gyro (5) is arranged to measure the rotation of the vessel (1) about an axis (X,Y,Z), which vessel during operation is subjected to at least
oscillating rotational motions of relative high frequency, which are centered about an equilibrium position which is assumed by the vessel (1) during operation, which rotational motions are performed about one or several axes (X,Z) which in the equilibrium position are horizontal, as well as to
vertical translational motions of relative low frequency, which vessel (1) furthermore comprises a three-axial accelerometer (20) for measuring the acceleration of the vessel (1) along three directions (X,Y,Z) which together span the three-dimensional space, where the output signal from the gyro (50) regarding the rotation about the said axis (X,Y,Z) is caused to be low pass filtered so that a low pass filtered gyro signal is achieved, where an inclination signal, which is caused to be comprised by the measurement value of the accelerometer (20) or to be calculated from the measurement values of the accelerometer (20), which inclination signal represents rotation of the vessel (1) about said axis (X,Y,Z), is caused to be low pass filtered so that a low pass filtered inclination signal is achieved, where a controller (51,52,53) is caused to compensate the output signal from the gyro (50) regarding gyro drift, which compensation is based upon the difference between the two low pass filtered signals, characterised in the combination of
firstly, that the cut-off frequency of the low pass filtration of the inclination signal is selected so that it is larger than at least a typical oscillation frequency for the vertical translation motions and at the same time smaller than a typical frequency for the rotational motions, so that the low pass filtered inclination signal does not comprise rotation motions with frequencies above the said cut-off frequency,
secondly in that a total force vector is caused to be calculated based upon all three measurement values of the accelerometer (20), which total force vector represents the total acceleration of the vessel (1), including the acceleration of gravity, and
thirdly in that the inclination signal is caused to be calculated based upon the total force vector, whereby it is exploited that the vertical translation motions are parallel to gravity, so that the low pass filtered inclination signal is unaffected by the vertical acceleration of the vessel which arises as a consequence of the vertical translation motions.

14. Method according to claim 13, characterised in that, before the value of the inclination signal is caused to be calculated, the measurement value or values of the accelerometer (20) continuously is or are caused to be adjusted so that it or they are compensated for possible known acceleration of the vessel (1) which instantaneously is achieved via the controls for maneuvering of the vessel (1), by subtracting such known acceleration from the measurement value or values of the accelerometer (20).

15. Method according to claim 14, characterised in that the measurement value of values of the accelerometer (20) continuously is or are caused to be adjusted so that it or they are compensated for a known acceleration in the form of a possible linear acceleration or retardation in the direction (Z) of travel of the vessel (1), in that a speedometer (30,40) is caused to continuously measure the velocity of the vessel (1), and in that this acceleration or retardation is caused to be calculated based upon the same velocity and thereafter is caused to be subtracted from the measurement value or values from the accelerometer (20), which thereby is adjusted.

16. Method according to claim 15, characterised in that one of the measurement directions (X,Y,Z) of the accelerometer (20) is caused to coincide with the longitudinal direction of the vessel (1), and in that the measurement values of the accelerometer (20) are caused to be compensated for the known acceleration as a result of a velocity change of the vessel (1) by subtracting the measured, known acceleration from the known measurement value of the accelerometer (20) in the longitudinal direction of the vessel (1).

17. Method according to claim 14, characterised in that the measurement value or values of the accelerometer (20) continuously is or are caused to be adjusted so that it or they are compensated for a known acceleration in the form of a possible centrifugal force perpendicularly to the direction (Z) of travel of the vessel (1) arising as a consequence of the vessel (1) yawing, in that a speedometer (30,40) is caused to continuously measure the velocity of the vessel (1), in that the rotation per unit time of the vessel (1) in the yawing plane continuously is caused to be measured, and in that the known acceleration is caused to be calculated based upon said velocity and rotation per unit time and thereafter to be subtracted from the measurement value or values of the accelerometer (20) which are thereby adjusted.

18. Method according to claim 17, characterised in that one of the measurement directions (X,Y,Z) of the accelerometer (20) is caused to be arranged in the horizontal plane and perpendicularly to the direction (Z) of travel of the vessel (1), and in that the measurement values of the accelerometer (20) are caused to be compensated for the known acceleration because of a centrifugal force which acts on the vessel (1) by subtracting the measured, known centrifugal force from the said measurement value of the accelerometer (20) perpendicularly to the longitudinal direction (Z) of the vessel (1).

19. Method according to claim 17, characterised in that said rotation per unit time is caused to be calculated based upon the measurement value from the gyro (50).

20. Method according to claim 15, characterised i n that the velocity of the vessel (1) is caused to continuously be calculated based upon measurement values from an existing log (40), GPS receiver (30) or the like on the vessel (1).

21. Method according to claim 13, characterised in that a gyro (50) is caused to be arranged to measure the rotation of the vessel (1) about an axis which is parallel to the longitudinal direction (Z) of the vessel, and in that the drift of said gyro (50) is caused to be compensated for using the low pass filtered inclination signal.

22. Method according to claim 13, characterised in that a gyro (50) is caused to be arranged to measure the rotation of the vessel (1) about an axis which is perpendicular to the direction (Z) of travel of the vessel (1) and also perpendicular to the plumb line when the vessel (1) is in the equilibrium position, and in that the drift of said gyro (50) is caused to be compensated using the low pass filtered inclination signal.

23. Method according to claim 13, characterised in that a gyro (50) is caused to be arranged to measure the rotation of the vessel (1) about an axis (Y) which is parallel to the plumb line when the vessel (1) is in the equilibrium position, and in that the drift of said gyro (50) is caused to be compensated using a low pass filtered signal from an existing compass (10) on the vessel (1).

24. Method according to claim 13, characterised in that all low pass filtrations have the same cut-off frequency.
